(19) United States
(12) Patent Application Publication
(10) Pub. No.: US 2017/0132753 A1
(43) Pub. Date: May 11, 2017

(54) DISPLAY DEVICE AND DISPLAY METHOD

(71) Applicant: Acer Incorporated, New Taipei City (TW)

(72) Inventors: Jui-Chieh HSIANG, New Taipei City (TW); Chao-Shih HUANG, New Taipei City (TW); Chih-Chiang CHEN, New Taipei City (TW); Hsu-Hsiang TSENG, New Taipei City (TW)

(21) Appl. No.: 15/011,983

(22) Filed: Feb. 1, 2016

(30) Foreign Application Priority Data
Nov. 5, 2015 (TW) 104136455

(51) Int. Cl. G06T 3/40; G06F 3/00

(52) U.S. Cl. CPC G06T 3/40; G06F 3/005

(57) ABSTRACT

A display method is provided, including: providing a screen, wherein the screen has a first display region and a second display region; detecting a position of a user relative to the screen, wherein a first distance is formed between the user and the first display region, and a second distance is formed between the user and the second display region; when the first distance is substantially the same as the second distance, the first display region displays a first image, and the second display region displays a second image; and when the second distance exceeds the first distance, the first display region displays the first image, and the second display region displays a third image, wherein the third image is the second image enlarged.

### CROSS REFERENCE TO RELATED APPLICATIONS

The present application is based on, and claims priority from, Taiwan Patent Application No. 104136455, filed on Nov. 5, 2015, the disclosure of which is hereby incorporated by reference herein in its entirety.

### BACKGROUND OF THE INVENTION

Field of the Invention

The application relates in general to a display method, and in particular, to a display method for generating a visual effect watching a curved screen.

Description of the Related Art

Recently, research indicates that a curved screen can reduce interference by external light and improve contrast. A user can comfortably watch images on the curved screen, and the images on the curved screen are not deformed or distorted. Thus, many different products with curved screens have been released. However, a curved screen is produced by a complex process, and is costly and occupies a large space relative to a flat screen. Most the users have been using flat screens recently. Therefore, how to provide a comfortable display method on a flat screen has become an important issue.

### BRIEF SUMMARY OF INVENTION

To address the deficiencies of conventional electronic products, an embodiment of the invention provides a display method, including: providing a screen, wherein the screen has a first display region and a second display region; detecting a position of a user relative to the screen, wherein a first distance is formed between the user and the first display region, and a second distance is formed between the user and the second display region; when the first distance is substantially the same as the second distance, the first display region displays a first image, and the second display region displays a second image; and when the second distance exceeds the first distance, the first display region displays the first image, and the second display region displays a third image, wherein the third image is the second image enlarged.

In some embodiments, a first included angle is formed between the first display region and the user, and a second included angle is formed between the second display region and the user, wherein the first included angle is substantially the same as the second included angle.

In some embodiments, when the first distance is substantially the same as the second distance, the area of the first display region is the same as that of the second display region.

In some embodiments, when the second distance exceeds the first distance, the area of the first display region exceeds that of the second display region.

In some embodiments, when the second distance exceeds the first distance, the first display region and the second display region are situated on a plane.

In some embodiments, the first distance is the shortest distance between the user and the screen.

An embodiment of the invention further provides a display device, including a screen and a detecting member for detecting a position of a user relative to the screen. The screen has a first display region and a second display region. A first distance is formed between the user and the first display region, and a second distance is formed between the user and the second display region. When the first distance is substantially the same as the second distance, the first display region displays a first image, and the second display region displays a second image. When the second distance exceeds the first distance, the first display region displays the first image, and the second display region displays a third image, wherein the third image is the second image enlarged.

In some embodiments, the detecting member includes an infrared detecting unit, an optical detecting unit, a sonic detecting unit, an ultrasonic detecting unit, or a photographic unit.

An embodiment of the invention further provides a display device, including a screen, a detecting member for detecting a position of a user relative to the screen, a rotating mechanism pivotally connected to the screen, and a bending mechanism. The screen has a first display region and a second display region. A first distance is formed between the user and the first display region, and a second distance is formed between the user and the second display region. When the first distance is different from the second distance, the bending mechanism bends the screen and the rotating mechanism rotates the screen, such that the first distance and the second distance are adjusted to be substantially the same.

In some embodiments, the detecting member includes an infrared detecting unit, an optical detecting unit, a sonic detecting unit, an ultrasonic detecting unit, or a photographic unit.

### BRIEF DESCRIPTION OF DRAWINGS

The invention can be more fully understood by reading the subsequent detailed description and examples with references made to the accompanying drawings, wherein:

FIG. 1 is a schematic diagram of a screen having a curved display surface according to an embodiment of the invention;

FIG. 2 is a schematic diagram of a screen having a flat display according to an embodiment of the invention;

FIG. 3A is a schematic diagram of a display device according to an embodiment of the invention;

FIG. 3B is a schematic diagram of a display device according to another embodiment of the invention;

FIG. 3C is a schematic diagram of an image of a virtual screen according to another embodiment of the invention;

FIG. 3D is a schematic diagram of an image of a screen according to another embodiment of the invention; and

FIGS. 4A-4C are schematic diagrams of the display device according to another embodiment of the invention.

### DETAILED DESCRIPTION OF INVENTION

The making and using of the embodiments of the display device and the display method are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted by an idealized or overly formal manner unless defined otherwise.

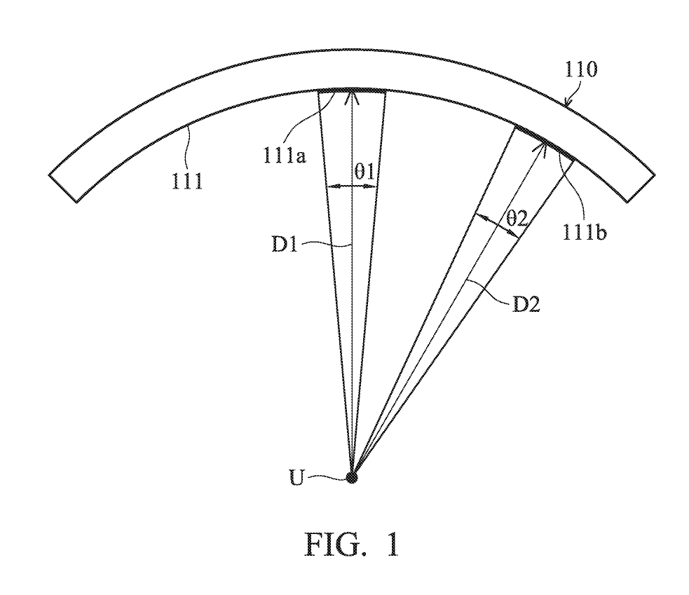

Referring to FIG. 1, in an embodiment of the invention, a display signal is input to a screen 110. The screen 110 has a curved display surface 111, and each portion of the display surface 111 substantially has the same radius of curvature. Thus, when the user U is situated at a predetermined position, the distances between every portion of the display surface 111 and the user U are substantially the same.

It should be noted that the curvature of the display surface 111 is similar to the curvature of the human cornea. Therefore, when the display signal is input to the screen 110 and the user U is situated at the determined position to watch an image displayed on the display surface 111, the viewing experience can be improved, and the burden on the eyes can be reduced.

As shown in FIG. 1, the predetermined position of the user U can be defined as the center, and the area around the center can be divided into several blocks by a predetermined angle, such that a plurality of display regions can be defined on the display surface 111 of the screen 110. A first display region 111a is situated at the center of the screen 110, and a second display region 111b is beside the first display region 111a. The first display region 111a displays a first image, and a first distance D1 and a first included angle θ₁ are formed between the first display region 111a and the user U. The second display region 111b displays a second image, and a second distance D2 and a second included angle θ₂ are formed between the second display region 111b and the user U. Since the distances between every portion of the display surface 111 and the user U are substantially the same, D1=D2. Moreover, since θ₁=θ₂ (the predetermined angle), the area of the first display region 111a is substantially the same as that of the second display region 111b.

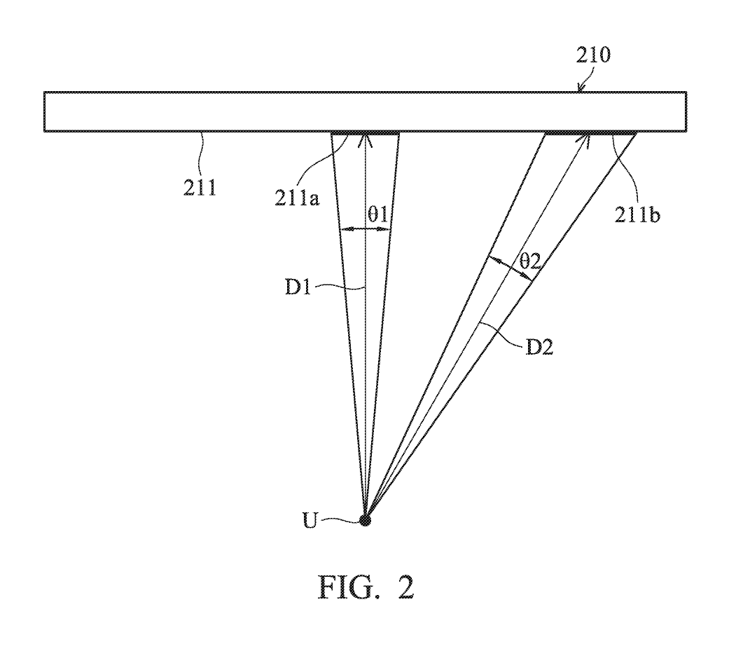

Referring to FIG. 2, a screen 210 comprises a flat display surface 211. The user U is situated on the central axis of the screen 210, and a distance D1 is formed between the display surface 211 and the user U. Similarly, the predetermined position of the user U can be defined as a center, and the area around the center can be divided into several blocks by a predetermined angle, such that a plurality of display regions can be defined on the display surface 211 of the screen 210. A first display region 211a corresponds to a first included angle θ₁, and a second display region 211b corresponds to a second included angle θ₂. As shown in FIGS. 1 and 2, the area of the first display region 211a of the flat display surface 211 is substantially the same as that of the first display region 111a of the curved display surface 111, and the area of the second display region 211b of the flat display surface 211 exceeds that of the second display region 111b of the curved display surface 111. Thus, when the aforementioned display signal is input to the screen 210, the first display region 211a displays the first image, and the second display region 211b displays a third image, wherein the third image is the second image enlarged.

In other words, the experience of viewing a curved screen can be generated on a flat screen using the display method of the invention.

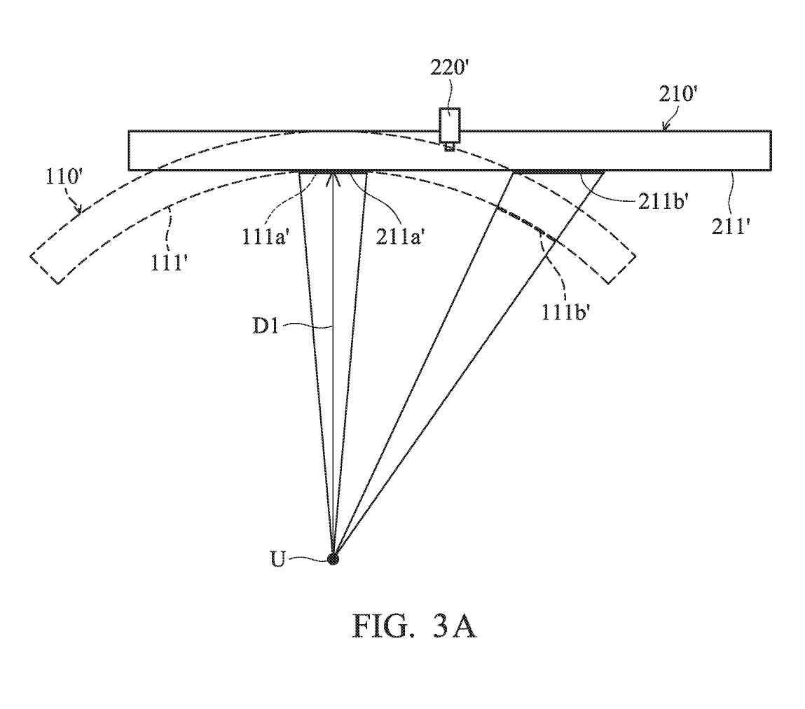

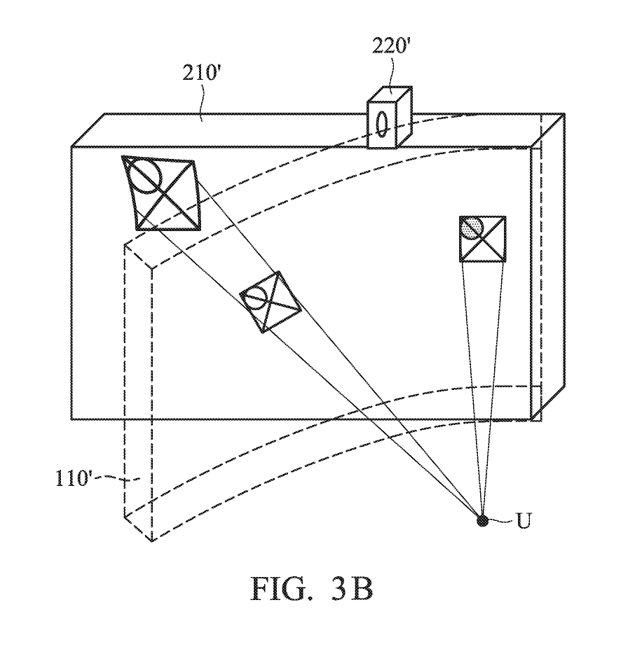

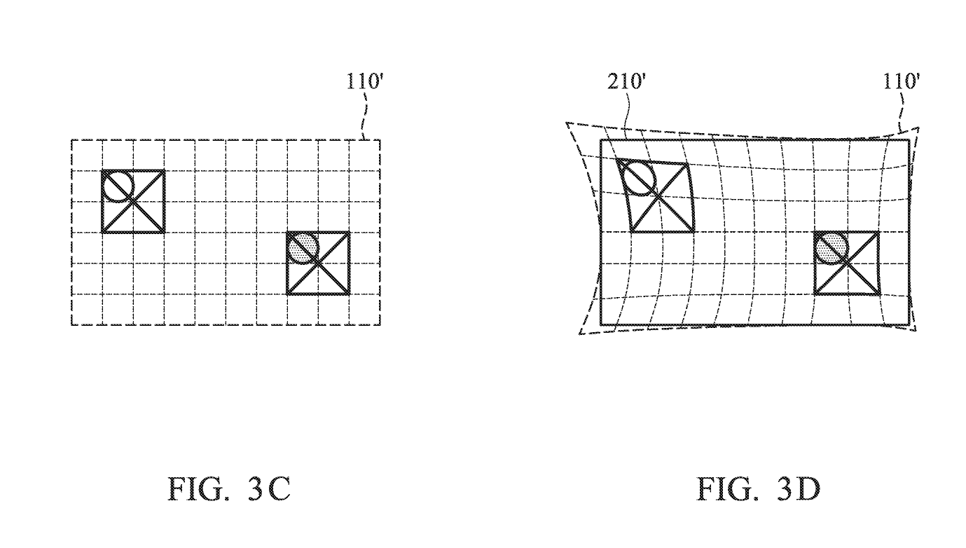

By using the aforementioned display method, the experience of viewing a curved screen can be generated even if the user is not situated on the central axis of the screen. Referring to FIG. 3A, in an embodiment, the display device comprises a screen 210′, a detecting member 220′, and a processing unit (not shown) disposed in the screen 210′. The detecting member 220′ can be an infrared detecting unit, an optical detecting unit, a sonic detecting unit, an ultrasonic detecting unit, or a photographic unit. First, the detecting member 220′ can detect the position of the user U relative to the screen 210′. The shortest distance between the aforementioned position and the screen 210′ is a first distance D1. The processing unit can assume a virtual screen 110′ having a curved display surface 111′, and the distances between every portion of the display surface 111′ and the user U are substantially the same (the first distance DO.

Subsequently, the position of the user U can be defined as a center, and the area around the center can be divided into several blocks by a predetermined angle, such that a plurality of display regions can be defined on the display surface 211′ of the screen 210′ and the display surface 111′ of the screen 110′. The display surface 211′ comprises a first display region 211a′ and a second display region 211b′, and the display surface 111′ comprises a first display region 111a′ and a second display region 111b′. When the display signal is input, the first display region 111a′ and the second display region 111b′ should respectively display a first image and a second image. Since the first display region 211a′ and the first display region 111a′ is substantially the same, and the area of the second display region 211b′ exceeds that of the second display region 111b′, the first display region 211a′ and the second display region 211b′ respectively display the first image and a third image, wherein the third image is the second image enlarged. Therefore, no matter where the user U is situated relative to the screen 210′, the visual effect of watching a curved screen can be generated.

It should be noted that the predetermined angle (the first included angle θ₁ and the second included angle θ₂) can be determined according to a desired image resolution. If the desired image resolution is high, the predetermined angle can be reduced. If the desired image resolution is low, the predetermined angle can be enlarged.

Furthermore, in order to prevent a discontinuous feeling produced at the boundary between adjacent display regions, the distance between the user U and the screen 210′ should exceed the shortest distance calculated by the following formula:

$$shortest distance = \frac{image resolution}{tan ( \frac{viewing angle}{60} \times \frac{π}{180} )}$$

The image resolution is the image resolution of the screen 210′, such as pixels per inch (ppi). The viewing angle is adjusted according to the user's vision.

Furthermore, the aforementioned display method can not only be adjusted along a horizontal direction, but also along a perpendicular direction, or along the horizontal and perpendicular directions both. As shown in FIGS. 3B-3D, the screen 210′ and the virtual screen 110′ can be divided into a plurality of display regions aligned in an array. When the display signal is input, the screen 110′ should display the images in FIG. 3C. After the images are adjusted according to the aforementioned display method, the screen 210′ displays the images in FIG. 3D. Specifically, the variation of the image adjacent to the user U is less than that of the image away from the user U.

In some embodiments, the images on the curved screen can be adjusted to generate the visual effect of a flat screen by the same principle. That is, the curved screen can display the reduced image on the corresponding position.

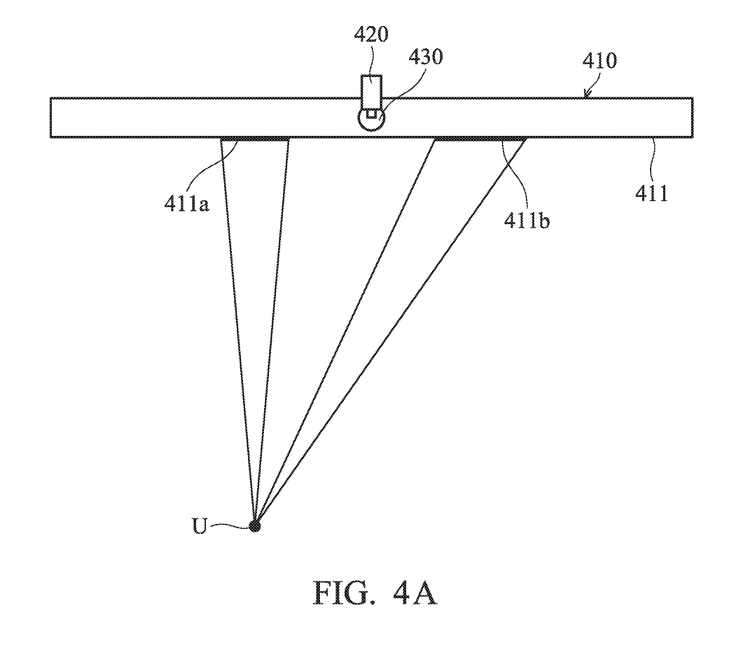

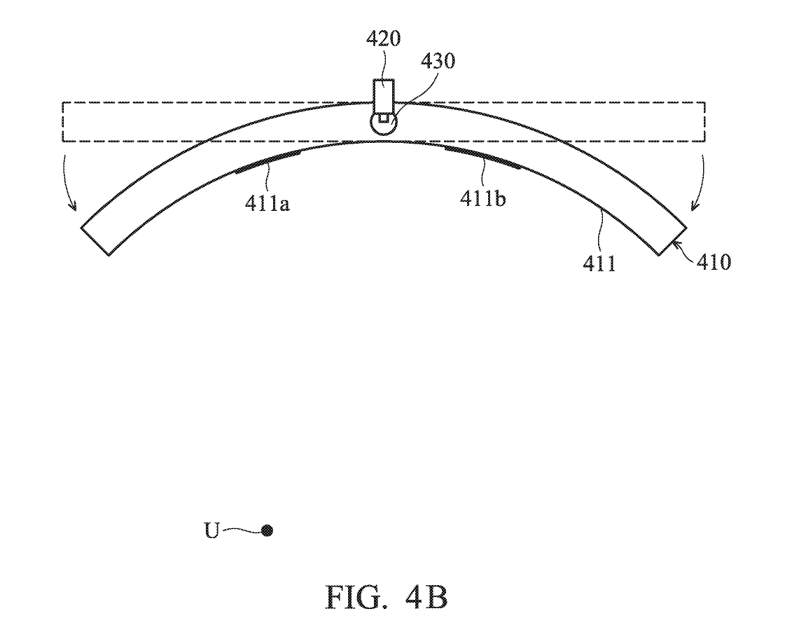

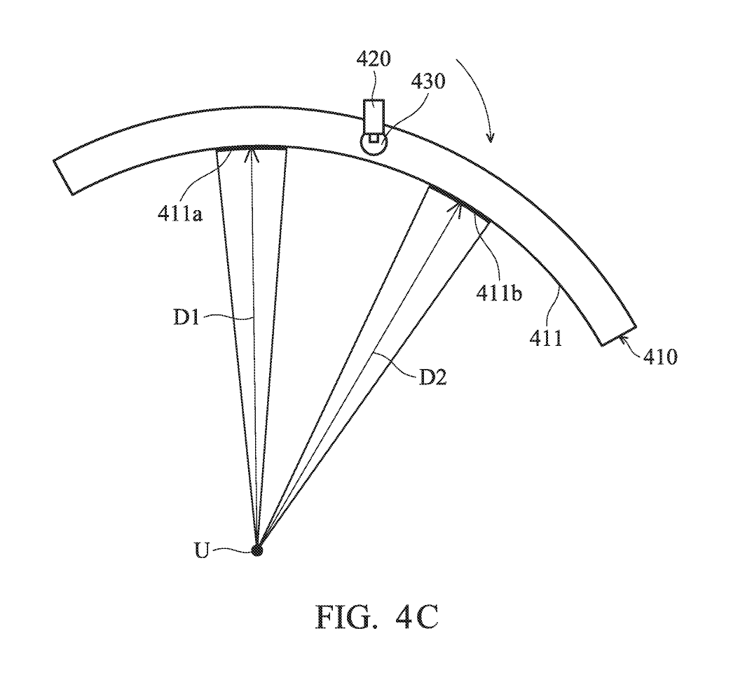

Referring to FIGS. 4A-4C, in another embodiment, the display device comprises a screen 410, a detecting member 420, a rotating mechanism 430, and a bending mechanism (not shown). The rotating mechanism 430 is pivotally connected to the screen 410. The display surface 411 of the screen 410 has a first display region 411a and a second display region 412a. First, the detecting member 420 can detect the position of the user U. Second, the bending mechanism can bend the screen 410, and the display surface 411 of the screen 410 can have the curvature of the human cornea (FIG. 4B). Last, the rotating mechanism 430 rotates clockwise, and the user U is situated on the central axis of the screen 410 (FIG. 4C). Therefore, the distances between every portion of the display surface 411 of the screen 410 and the user U are the same. The first distance D1 between the user U and the first display region 411a is the same as the second distance D2 between the user U and the second display region 411b. The viewing experience can be improved.

In some embodiments, when the detecting member 420 detects a plurality of users in front of the screen 410, the rotating mechanism 430 and the bending mechanism are disabled, such that the shape of the screen 410 can be maintained for viewing by multiple viewers.

In summary, by using the display device and the display method of the invention, the flat screen can provide the same viewing experience as a curved screen. The viewing experience of the user can be improved, and the burden on the eyes can be reduced.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A display method, comprising:
providing a screen, wherein the screen has a first display region and a second display region;
detecting a position of a user relative to the screen, wherein a first distance is formed between the user and the first display region, and a second distance is formed between the user and the second display region;
when the first distance is substantially the same as the second distance, the first display region displays a first image, and the second display region displays a second image; and
when the second distance exceeds the first distance, the first display region displays the first image, and the second display region displays a third image, wherein the third image is the second image enlarged.

2. The display method as claimed in claim 1, wherein a first included angle is formed between the first display region and the user, and a second included angle is formed between the second display region and the user, wherein the first included angle is substantially the same as the second included angle.

3. The display method as claimed in claim 1, wherein when the first distance is substantially the same as the second distance, the area of the first display region is the same as that of the second display region.

4. The display method as claimed in claim 1, wherein when the second distance exceeds the first distance, the area of the first display region exceeds that of the second display region.

5. The display method as claimed in claim 1, wherein when the second distance exceeds the first distance, the first display region and the second display region are situated on a plane.

6. The display method as claimed in claim 1, wherein the first distance is the shortest distance between the user and the screen.

7. A display device, comprising:
a screen, comprising a first display region and a second display region; and
a detecting member, detecting a position of a user relative to the screen, wherein a first distance is formed between the user and the first display region, and a second distance is formed between the user and the second display region, wherein when the first distance is substantially the same as the second distance, the first display region displays a first image, and the second display region displays a second image, wherein when the second distance exceeds the first distance, the first display region displays the first image, and the second display region displays a third image, wherein the third image is the second image enlarged.

8. The display device as claimed in claim 7, wherein the detecting member comprises an infrared detecting unit, an optical detecting unit, a sonic detecting unit, an ultrasonic detecting unit, or a photographic unit.

9. A display device, comprising:
a screen, comprising a first display region and a second display region;
a detecting member, detecting a position of the user relative to the screen, wherein a first distance is formed between the user and the first display region, and a second distance is formed between the user and the second display region;
a rotating mechanism, pivotally connected to the screen; and
a bending mechanism, wherein when the first distance is different from the second distance, the bending mechanism bends the screen and the rotating mechanism rotates the screen, such that the first distance and the second distance are adjusted to be substantially the same.

10. The display device as claimed in claim 9, wherein the detecting member comprises an infrared detecting unit, an optical detecting unit, a sonic detecting unit, an ultrasonic detecting unit, or a photographic unit.
